(19) United States
(12) Patent Application Publication
(10) Pub. No.: US 2017/0282921 A1
(43) Pub. Date: Oct. 5, 2017

(54) METHOD FOR OPERATING A MOTOR VEHICLE HAVING A START-STOP SYSTEM, AND ASSOCIATED MOTOR VEHICLE

(71) Applicant: AUDI AG, Ingolstadt (DE)

(72) Inventor: Reimund LIMBACHER, Ingolstadt (DE)

(21) Appl. No.: 15/514,465

(22) PCT Filed: Jul. 22, 2015
(86) PCT No.: PCT/EP2015/001504

§ 371 Date: Mar. 24, 2017

(30) Foreign Application Priority Data
Sep. 25, 2014 (DE) 10 2014 014 293.0

(51) Int. Cl. B60W 30/18

(52) U.S. Cl. CPC B60W 30/18018; B60W 30/181; B60W 2550/147; B60W 2550/22; B60W 2420/00

(57) ABSTRACT

A method for operating a motor vehicle with a start/stop system (2) for a combustion engine (4) of a motor vehicle (1) with a device (3) for detecting an area ahead of the vehicle, wherein the start/stop system (2) stops the combustion engine (4) if a speed of the motor vehicle (1) depending on at least one signal relating to the driving dynamic of the vehicle (1) falls below a limit value, wherein the combustion engine (4) is not stopped if a road unevenness that requires decelerated driving over is detected in the area ahead of the vehicle by means of the device for detecting the area ahead of the vehicle.

The invention relates to a method for operating a motor vehicle with a start/stop system for a combustion engine, with a device for detecting an area ahead of the vehicle, wherein the start/stop system stops the combustion engine if a speed of the motor vehicle depending on at least one signal relating to the driving dynamic of the motor vehicle falls below a limit value.

Often times, modern motor vehicles have a start/stop system, which stops the engine of the motor vehicle if the motor vehicle is stopped, during waiting phases at traffic lights, for example, in order to save fuel.

It is also known that the start/stop system stops the combustion engine of the motor vehicle not only if it is stopped but also if it is below a limit value of a speed, e.g., if rolling to a stop toward a traffic light.

The stopping of the combustion engine below a previously defined limit value of a speed of the motor vehicle can result in the undesired effect that the combustion engine is stopped in situations in which the driver only wants to achieve a reduction of the speed of the motor vehicle because of a road unevenness located ahead of the vehicle, for example.

From DE 10 2008 064 018 A1 a method and a device for changing an operating mode of a combustion engine of a vehicle are known. In doing so, geographic or topographic information regarding an object other than the vehicle is used in order to prevent an undesired stopping of the combustion engine. However, a reduction of the speed required as a result of road unevennesses is not included in the geographic or topographic information.

It is therefore the object of the invention to provide a method that is improved in this regard.

To achieve the object, a method of the aforementioned type provides according to the invention that the combustion engine is not stopped if a road unevenness that requires decelerated driving over is detected in the area ahead of the vehicle by means of the device for detecting the vehicle environment.

In situations, where the device for detecting the area ahead of the vehicle detects a road unevenness that requires decelerated driving over, an undesired stopping of the combustion engine of the motor vehicle is thus prevented. Compared to the prior art, this offers the advantage that an undesired delaying effect, a so-called hesitation, does not occur. This hesitation occurs if the engine is undesirably turned off and if, in the case of an automatic transmission, the transmission clutch is brought into the neutral position so that the drag delay of the drive is reduced. In order to accelerate, the engine must be restarted and the transmission engaged.

In particular in case of road unevennesses in the form of a speed bump placed on the road or of rails traversing or crossing the road, an undesired turning off of the combustion engine is disadvantageous or even safety-critical. A speed bump placed on the road, i.e. a structural elevation, disposed transverse to the driving direction, on the road, which is to contribute to a deliberate reduction of the speed and to traffic calming, can be designed as a circular segment bump, as a plateau-shaped or pillow-like bump, or in the shape of a round plate. Such a speed bump is often also called a sleeping policeman, a speed hump, or a speed breaker, and is preferably disposed in traffic areas in which traffic calming is required, such as at village entrances, on play streets, or in similar areas.

A reduction of the speed to below the limit value (which is, for example, between 2-20 km/h), at which the start/stop system stops the combustion engine, is also required in areas of rails, railroads, or trolleys, in particular if the rail installation has speed bumps for the crossing traffic. Precisely in these cases, it is interfering or safety-critical for the driver of the motor vehicle if the drive of the combustion engine is only available in a delayed manner, since it was stopped by the start/stop system as a result of the falling below the speed limit value. This undesired delaying effect is prevented by the method according to the invention, since the rails are detected by the device for detecting the area ahead of the vehicle and the combustion engine is therefore not stopped.

The device for detecting the area ahead of the vehicle detects the road unevenness based on cameras and/or by means of laser scanners and/or by means of radar. In doing so, the area ahead of the motor vehicle is recorded in order to detect vertical unevennesses. Such laser scanners are partially already installed in modern motor vehicles, for predictive suspension systems, for example. These devices can also function based on cameras, which also offers the possibility of detecting lane markings or traffic signs, in particular signs that indicate road unevennesses or other reasons for a required reduction of the speed.

A preferred development of the method according to the invention consists in the motor vehicle comprising a control device, which analyzes the detected road unevenness by means of a pattern recognition algorithm, in particular by edge detection, and controls the entire start/stop system. Accordingly, it is possible to analyze the data acquired by means of the device for detecting the area ahead of the vehicle, the road unevenness or traffic signs, speed bumps, rails, other vehicles or other objects that require a reduction of the speed. For this purpose, traffic signs can be identified on the one hand, the meaning of which indicates an upcoming reduction of the speed. Furthermore, patterns, which are applied for better visibility, on speed bumps can be detected. By means of edge detection, speed bumps or rails or similar road unevennesses can also be detected. In doing so, it is further possible to draw on the fixed rail spacing as identifying feature for easier detection.

A particularly preferred embodiment of the invention consists in the road unevenness being checked for plausibility by means of at least one piece of information. Thus, it is possible to verify, if due to a point in the road detected by the device for detecting the area ahead of the vehicle and analyzed and identified as a road unevenness by the control device only a temporary reduction of the speed is upcoming and thus a stopping of the combustion engine must be prevented or whether a falling below the limit value of the speed of the motor vehicle is to result in a turning off of the combustion engine.

For this purpose, the information for the plausibility check includes predictive route data, preferable sign recognition data and/or position data of a GPS receiver or a navigation system. This offers the advantage that a detected rail, for example, can be checked for plausibility in that a navigation system can verify whether a railroad track crosses the road. If this is the case, a correct detection of a rail can be assumed. Signs that indicate a railroad crossing or road unevennesses and are detected by means of a camera can also be drawn upon for the plausibility check.

In addition, a brake pressure and/or an acceleration of the motor vehicle can also be taken into consideration as a signal. In doing so, it is possible to establish a relation between the speed or deceleration and the detected unevennesses of the road. Based on this relation, it is possible to determine whether a braking process occurs, which is to result in the complete stopping of the motor vehicle, or whether a reduction of the speed occurs in order to slowly drive through a certain area.

It thereby proves advantageous that the acceptance of start/stop systems can be prevented by avoiding an undesired stopping of the combustion engine. This has the consequence that a potential driver also has the start/stop system activated in areas through which slow driving is required and does not turn the start/stop system off, which results in a saving of fuel both when stopped and during a drive below the speed limit value.

In addition to the method, the invention also relates to a motor vehicle with a start/stop system for a combustion engine, with a device for detecting an area ahead of the vehicle, wherein the start/stop system is designed to stop the combustion engine if a speed of the motor vehicle depending on at least one signal relating to the driving dynamic of the motor vehicle falls below a limit value, wherein the start/stop system is designed to stop the combustion engine depending on a road unevenness detected in the area ahead of the vehicle by means of the device for detecting the area ahead of the vehicle.

The start/stop system does not stop the combustion engine of the motor vehicle if the device for detecting an area ahead of the vehicle detects in the area ahead of the vehicle a road unevenness that requires decelerated driving over. An undesired stopping of the combustion engine is thereby prevented. The driver, who only reduces the speed of the motor vehicle as a result of the road unevenness and wants to accelerate again afterwards, can do so as a result of the prevented turning off of the combustion engine, wherein no hesitation occurring as a result of the turning off of the combustion engine causes a delay.

For this purpose, the device for detecting the area ahead of the vehicle is preferably designed to detect a speed bump placed on the road or a rail crossing the road as a road unevenness. Areas, in which speed bumps or rails crossing the road are present, require a reduction of the speed whereby it is sensible not to turn of the combustion engine, since subsequent to the driving through at reduced speed, an acceleration to the initial speed is to take place, for example.

The device for detecting the area ahead of the vehicle is preferably designed as a lidar, radar, camera, or laser scanner. In this way, it is possible to detect any road unevennesses in the area ahead of the motor vehicle and to also detect other environmental information, such as street signs, that indicate the upcoming reduction of a speed.

The motor vehicle according to the invention furthermore comprises a control device, which is designed to analyze the detected road unevenness by means of a pattern recognition algorithm, in particular by means of edge detection, and to control the entire start/stop system. Accordingly, any road unevenness can be identified by means of the pattern algorithm. Preferably, rails or speed bumps extending transversely to the road can be detected by means of edge detection and can be identified as such via the analysis by the control device, and the start/stop system can be controlled accordingly.

A preferred development of the motor vehicle according to the invention consists in at least one piece of information for the plausibility check, in particular route data, sign detection data, or position data from a GPS receiver or a navigation system being able to be transmitted to the control device and processed there. This plausibility check has the task of checking a detected road unevenness for consistency. For this purpose, route data can be used, which, for example, allow the check as to whether a detected rail crosses the lane as a result of a railroad track recorded in a navigation system. It is also possible to suggest, by means of sign detection, an area that is to be driven through at a reduced speed, such as a speed limit or a play street or information regarding road damages. By means of this plausibility check, a reduction in speed by the driver can be ascribed based on the information to a situation existing, in which a turning off of the combustion engine is undesired.

Furthermore, the control device may be designed to take a brake pressure and/or an acceleration of the motor vehicle into consideration as a signal. This has the advantage that a turning off of the combustion engine is prevented in case of an acceleration of the motor vehicle. Depending on the brake pressure exerted by the driver, it can be decided with respect to the detected unevenness whether a situation exists, in which a turning off of the combustion engine is undesired.

The invention is explained in the following by means of exemplary embodiments with reference to the drawings. The drawings are schematic representations and show:

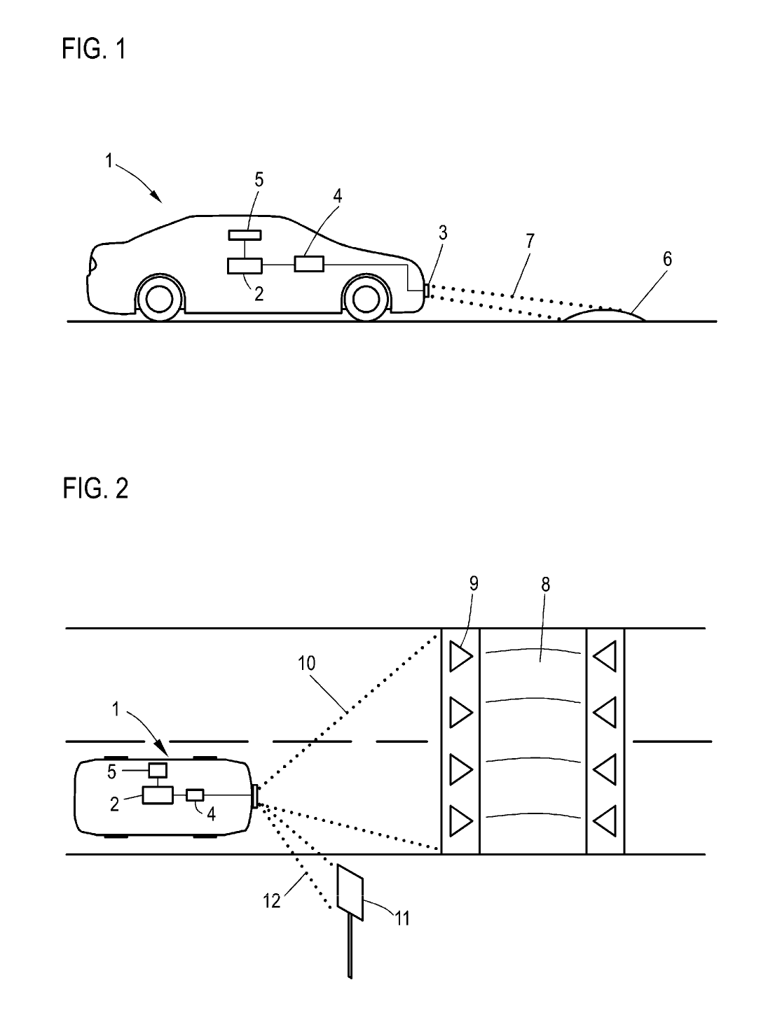

FIG. 1 a lateral view of a motor vehicle according to the invention;

FIG. 2 a top view of the motor vehicle according to the invention of FIG. 1 in a first traffic situation;

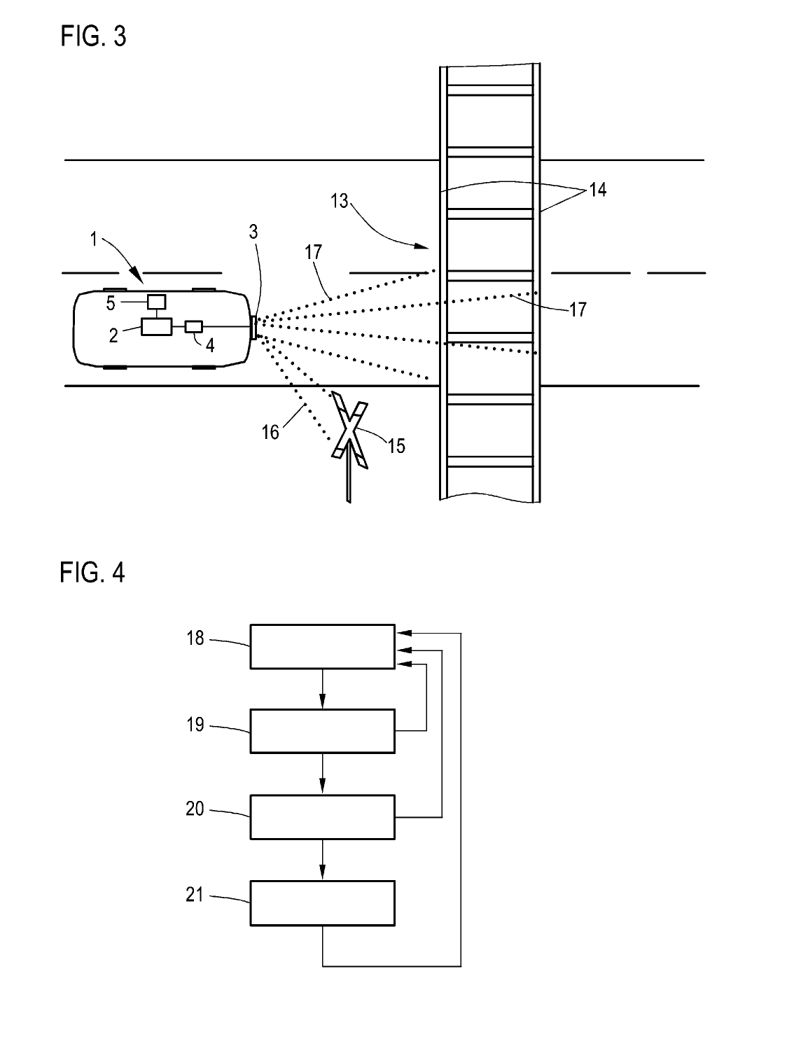

FIG. 3 a top view of the motor vehicle according to the invention of FIG. 1 in a second traffic situation; and

FIG. 4 a flow diagram of the method according to the invention.

FIG. 1 shows a motor vehicle 1 with a start/stop system 2 and a device 3 for detecting an area ahead of the vehicle. The start/stop system 2 is designed to stop a combustion engine 4 if a speed of the motor vehicle 1 depending on at least one signal relating to the driving dynamic of the motor vehicle 1 falls below a limit value. For this purpose, the start/stop system 2 is connected to a control device 5, to which the signal of appropriate sensors is transmitted, such as a pedal sensor, which detects the pedal path of the brake pedal. The device 3, which is disposed at the front of the motor vehicle 1, is designed to detect a road unevenness in the area ahead of the vehicle. FIG. 1 shows that a speed bump 6 is depicted in the area ahead of the motor vehicle 1. This speed bump is detected by the device 3, which is illustrated by the dotted lines 7. The speed bump 6 detected by the device 3 is analyzed by the control device 5 by means of an algorithm for edge detection. Based on the speed bump 6, which is detected as a road unevenness and which only requires a reduction of the speed, but for which a turning off of the combustion engine 4 is not desired, the control device 5 controls the start/stop system 2 such that the combustion engine 4 is not stopped, if the driver reduces the speed to below a limit value (e.g., from the interval between 2-20 km/h) in order to drive over the speed bump 6.

FIG. 2 shows the motor vehicle 1 of FIG. 1 in a top view of a situation similar to that in FIG. 1. In the area ahead of the motor vehicle 1 is a speed bump 8, which is designed as a plateau with ramps. Markings 9 are attached to the ramps of the speed bump 8, which are to improve the visibility of the speed bump for a driver.

These markings 9 can be detected based on videos by the device 3, which also comprises a camera in addition to a laser scanner. This is illustrated by the dotted lines 10. The markings 9 detected by the device 3 are analyzed by the control device 5 by means of a pattern recognition algorithm. The start/stop system 2 is subsequently controlled accordingly by the control device 5 so that the combustion engine 4 is not stopped. In front of the speed bump 8, a traffic sign 11 is disposed at the roadside. This traffic sign is also detected by the device 3 based on videos for plausibility purposes. This is illustrated by the dotted lines 12. The detected traffic sign is identified as a traffic sign by the control device 5 by means of a sign recognition algorithm. Since the traffic sign 11 indicates a traffic-calmed area and the markings 9 were also detected, the speed bump 8 is considered to be plausible. A stopping of the combustion engine 4 by the start/stop system 2 is prevented by the control device 5.

FIG. 3 shows a top view of the motor vehicle 1 in front of a railroad crossing 13. In this case, the detection device 3 detects the rails 14 by means of laser scanners. The detection of the rails 14 by the device 3 is in this case illustrated by the dotted lines 17. The detected data are analyzed as rails by the control device 5 by means of an edge detection algorithm. In addition to the rails 14, the device 3 detects at the roadside the St. Andrew's cross 15, which indicates a right of way of the rail traffic. The detection of the traffic sign 15 is in this case indicated by the lines 16. The control device 5 can analyze the traffic sign 15 by means of the sign recognition algorithm and thus obtains as result a plausibility check that the previously analyzed rails 14 were correctly detected as such. It is also possible that it is detected from map data from a navigation system of the motor vehicle 1 that the railroad track crosses the lane, forming the railroad crossing 13. This information may also be transmitted to the control device 5 and thus be drawn upon for the plausibility check. Based on the thus correctly detected railroad crossing 13, falling below the speed limit value will not result in the combustion engine 4 being turned off, but the control device 5 will control the start/stop system 2 such that a stopping of the combustion engine 4 is prevented.

FIG. 4 shows a flow diagram of a method for operating a start/stop system 2 for a combustion engine 4 of a motor vehicle 1 with a device 3 for detecting an area ahead of the vehicle, wherein the start/stop system 2 stops the combustion engine 4 if a speed of the motor vehicle 1 depending on at least one signal relating to the driving dynamic of the motor vehicle 1 falls below a predefined limit value or a limit value parameterizable by the driver.

The method starts in block 18 with the detection of the area ahead of the motor vehicle 1 by the device 3. The data acquired in this way are analyzed in block 19 by the control device 5. In doing so, it is determined whether a road unevenness is present in the acquired data. This is performed by means of pattern recognition algorithms, sign detection algorithms, and the like. If no road unevenness is detected in block 19, it is branched back to block 18, in which the area ahead of the vehicle is continued to be detected. If a road unevenness was analyzed in block 19 by the control device 5, it can be checked in block 20 whether the presence of a road unevenness is plausible. If this is not the case, a rail was, for example, incorrectly identified in an area, in which a railroad track does not cross the road according to the data of a navigation system, and it is branched back again from block 20 to block 18, in which the area ahead of the vehicle is detected. A prevention of the stopping of the combustion engine 4 by the control device 5 does not take place in this case.

If the driver reduces the speed of the motor vehicle 1 in this area, the start/stop system 2 stops the combustion engine 4 the speed of the motor vehicle 1 falls below the limit value. If, based on the optional plausibility check in block 20, the road unevenness detected in block 19 proves to be plausible, it is branched to block 21, in which the control device 5 controls the start/stop system 2 such that a stopping of the combustion engine 4 is prevented. Subsequently, it is branched back from block 21 to block 18, in which the detection of the area ahead of the vehicle takes place. A continuous method is thus specified, which can however also be performed in defined intervals.

1. A method, comprising: operating a motor vehicle with a start/stop system for a combustion engine of a motor vehicle with a device for detecting an area ahead of the vehicle, wherein the start/stop system stops the combustion engine if a speed of the motor vehicle depending on at least one signal relating to the driving dynamic of the motor vehicle falls below a limit value,
wherein
the combustion engine is not stopped if a road unevenness that requires decelerated driving over is detected in the area ahead of the vehicle by means of the device for detecting the area ahead of the vehicle.

2. The method according to claim 1,
wherein
a speed bump placed on the road or a rail crossing the road is detected as a road unevenness.

3. The method according to claim 1,
wherein
the device detects the road unevenness based on cameras and/or by means of laser scanners and/or radars.

4. The method according to claim 1,
wherein
the motor vehicle comprises a control device, which analyzes the detected road unevenness by means of a pattern recognition algorithm, in particular by means of edge detection, and controls the entire start/stop system.

5. The method according to claim 1,
wherein
the road unevenness is checked for plausibility by means of at least one piece of information.

6. The method according to claim 5,
wherein
the information comprises predictive route data, preferable sign recognition data and/or position data of a GPS receiver or a navigation system.

7. The method according to claim 1,
wherein
a brake pressure and/or an acceleration of the motor vehicle is taken into consideration as a signal.

8. A motor vehicle, comprising:
a start/stop system for a combustion engine with a device for detecting an area ahead of the vehicle, wherein the start/stop system is designed to stop the combustion engine if a speed of the motor vehicle depending on at least one signal relating to the driving dynamic of the motor vehicle falls below a limit value,
wherein
the start/stop system is designed to stop the combustion engine depending on a detected road unevenness in the area ahead of the vehicle.

9. The motor vehicle according to claim 8,
wherein
the device is designed to detect a speed bump placed on the road or a rail crossing the road as a road unevenness.

10. The motor vehicle according to claim 8,
wherein
the device is designed as a lidar, radar, camera, or laser scanner.

11. The motor vehicle according to claim 8,
further comprising a control device that is designed to analyze the detected road unevenness by means of a pattern recognition algorithm, in particular by means of edge detection, and to control the entire start/stop system.

12. The motor vehicle according to claim 11,
wherein
to the control device, at least one piece of information for the plausibility check, in particular route data, sign detection data, or position data from a GPS receiver or a navigation system can be transmitted.

13. The motor vehicle according to claim 11,
wherein
the control device is designed to take into consideration as a signal a brake pressure and/or an acceleration of the motor vehicle.
